(19) United States
(12) Patent Application Publication
(10) Pub. No.: US 2025/0095204 A1
(43) Pub. Date: Mar. 20, 2025

(54) SENSOR CALIBRATION SYSTEM

(71) Applicant: XRPRO, LLC, Boulder, CO (US)

(72) Inventors: Ivan Malin, Moscow (RU); Paulo E. Xavier da Silveira, Boulder, CO (US)

(21) Appl. No.: 18/727,181

(22) PCT Filed: Jan. 19, 2023
(86) PCT No.: PCT/US2023/060879

§ 371 Date: Jul. 8, 2024

Related U.S. Application Data
(60) Provisional application No. 63/266,983, filed on Jan. 21, 2022.

(51) Int. Cl. G06T 7/80; G06T 7/55; G06T 7/73

(52) U.S. Cl. CPC G06T 7/80; G06T 7/55; G06T 7/74; G06T 2207/20092; G06T 2207/30168; G06T 2207/30208

(57) ABSTRACT

A device can include sensors configured to detect depth information associated with objects in a three-dimensional environment. The device can have an auto-calibration system that can use images captured by the sensors to calibrate the sensors or determine whether additional images should be captured during the auto-calibration process.

### BACKGROUND

A device configurated to scan or map a three-dimensional (3D) space can include one or more cameras or other sensors that can capture images, depth information, and/or other data indicating the presence of objects in the 3D space. Depth information and/or corresponding images can be used to determine a distance between those objects and the device, and ultimately contribute to the calibration of one or more sensors of the device.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an illustrative example of a device in a physical environment according to some implementations.

FIG. 2 illustrates an example flow diagram showing a process for auto-calibrating one or more sensors of the device according to some implementations.

FIG. 3 illustrates an example flow diagram showing a process for auto-calibrating one or more sensors of the device according to some implementations.

FIG. 4 illustrates an example flow diagram showing a process for capturing frames and providing corresponding feedback during auto-calibration of one or more sensors according to some implementations.

FIG. 5 illustrates an example flow diagram showing a process for determining a geometry cost function according to some implementations.

FIG. 6 shows an example system according to some implementations.

### DETAILED DESCRIPTION

This disclosure includes techniques and implementations for a system or device that may be used for autocalibration of a sensor, such as a debt sensor. For instance, in some implementations, a downloadable or otherwise hostable application may be installed and engaged on a user device while an image sensor of the user device is engaged to capture still shots or frames of a calibration chart positioned within a physical environment. In other cases, the still frames may be captured of known objects (e.g., furniture, doors, windows, and the like) or surfaces (e.g., planes, ceilings, floors-tile or wood, walls, and the like) within the physical environment. The application or related systems (such as cloud-based systems) may then utilize the frames to determine an accuracy of the calibration of the image sensor and/or sensor parameters that are used to calibrate the image sensor. As one example, the determined sensor parameters may be associated with an attached device (such as a lens, depth sensor, or other sensor that relies at least in part on an embedded sensor of the user device). In other cases, the accuracy and/or parameters may be used by the application or the user to update or more precisely tune the embedded image sensors.

In some examples, the application will provide a user interface that will instruct the user to captures frames until sufficient frames are generated such that the accuracy and/or parameters may be determined. In some cases, the user instructions, via the user interface, may include a number of frames, direction of image sensor, objects or surfaces to be captured or represented in the frames, and the like. In one specific example, the application may instruct the user to utilize a tripod (or other device stabilizer) to capture paired still frames. In some cases, the application may instruct the user to capture a video sequence of adjacent frames having different motion representations (e.g., vertical movement, horizontal movement, spin, rotation, and the like).

In some examples, the device may determine the accuracy using a computed error distribution representative of an estimated image sensor parameters. For instance, a Gaussian distribution with a computed covariances that is determined or simulated via a Monte-Carlo technique may be determined. The error may also be represented as a depth map of the physical environment. In some cases, the accuracy may be provided via the user interface as a percentage, measurements (such as to a nearest millimeter), colors, heatmap, scores, and the like.

In some cases, the application may be configured to determine a metric or score associated with each frame and only utilize frames having greater than or equal to a predetermined quality score to determine the accuracy or parameters. For example, the application may discard frames with high motion, defocus blur, low lighting, partial target (e.g., chart, object, or surface), too close to the target, too far from the target, or the like. If a frame is discarded, the application may provide, via the user interface, feedback to the user on how to improve the quality of one or more subsequent frames.

In some cases, the application may also perform depth calibration for a depth sensor using a scene or frames representing differently oriented surfaces. The application may either concurrently or iteratively optimize both for camera poses and calibration parameters to achieve the greater than a desired consistency of the geometry captured from different frames (e.g., subsequent frames). The metrics of consistency may include points proximity, surface normal directions, and the like. The application may also optimize either camera parameters or calibrate a residual depth-error field.

In implementations associated with add-on or auxiliary sensor systems, the application may utilize data from an inertial measurement unit (IMU) 122 or other position or orientation based sensor (e.g., accelerator, gyroscope, magnetometer, gravimeters, or the like). The additional IMU data may be usable together with the frames (such as via a time stamp) to determine the accuracy or parameters (such as calibration parameters).

As discussed herein, the application may be hosted or downloaded onto a user device. It should also be understood that some or all of the processing may be performed by a cloud-based services that may receive the data (e.g., frames) via a communicator interface of the device.

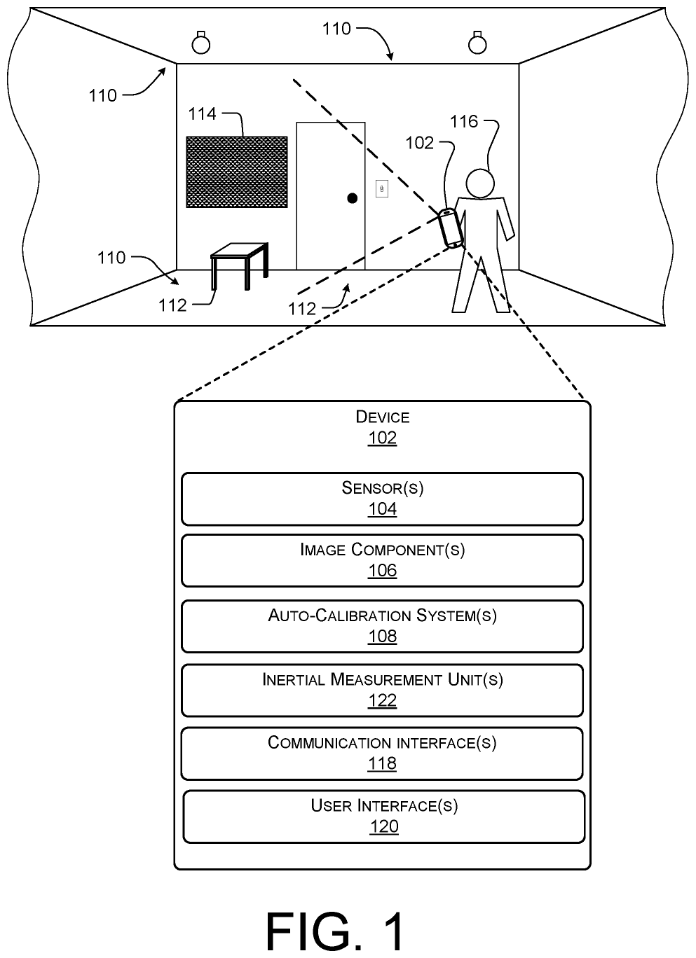

FIG. 1 shows an example 100 of a device or system 102 in a physical environment. An application associated with the device 102 may be configured to map or otherwise scan the physical environment, for instance, to identify objects in the physical environment, capture or generate 3D scans of objects, determine a position of the device 102 in the physical environment relative to one or more objects, and/or otherwise map or scan the physical environment and/or associated objects. In some examples, the device 102 can use computer-based vision or machine-learning techniques, including deep learning, to detect objects, interact with objects, and/or navigate through the physical environment.

In some examples, the device 102 may be a smartphone or other user device. In other examples, the device 102 can be a peripheral or attachment that can be connected to a smartphone, a tablet, a personal computer, a laptop, or other user device, or a combination of a user device and the peripheral. In additional examples, the device 102 can be a virtual reality headset, an augmented reality headset, an environmental scanner, an object scanner, or other device. In still other examples, the device 102 can be a robot, drone, or other autonomous vehicle or device that can move around the physical environment in part based on mapping the physical environment and detecting object in the physical environment.

The device 102 can include one or more sensors 104, including one or more image components 106 (e.g., cameras). The image components 106 can be configured to capture still images and/or video, such as visible light sensors, infrared sensors, multispectral sensors, and/or types of sensors. The image components 106 or other types of sensors 104 can also be depth sensors, such as depth-from-stereo cameras, time-of-flight cameras, LiDAR sensors, or any other type of camera or sensor configured to detect or measure depth or distance information. In some examples, the sensors 104 can also include IMUs 122 or other orientation and position related sensors configured to measure one or more of velocity, acceleration, and/or orientation, such as gyroscopes, accelerometers, and/or magnetometers.

The device 102 can use depth information, visual information, and other data provided by the sensors 104 to determine distances between the device 102 and objects or surfaces in the physical environment, and/or distances between the device 102 and various portions of individual objects. The device 102 can, accordingly, use such distance information to determine a position of the device 102 within the physical environment and/or relative to individual objects or surfaces, to scan the physical environment and/or individual objects, and/or for other purposes. In some situations, the sensors 104 can become uncalibrated, such that depths determined by the device 102 may become inaccurate (e.g., include an error greater than or equal to a threshold). However, the device 102 can have an auto-calibration system 108 that can automatically calibrate depth determinations generated based on data from the sensors 104. The depth calibration can be performed based at least in part on images (e.g., frames or video) and other data captured by image components 106 or other sensors 104.

The auto-calibration system 108 can calibrate the sensors 104 by adjusting one or more calibration parameters. The calibration parameters can be intrinsic parameters associated with cameras and/or other types of sensors 104, such as an image center parameter, focal lengths in horizontal and vertical directions, non-linear distortion parameters of one or more orders, horizontal and vertical image center parameters, and/or other types of parameters. The calibration parameters can also, or alternately, be extrinsic parameters associated with, or between, sensors 104, such as three-dimensional rotation parameters, offset parameters, and/or other types of parameters. The calibration parameters can also be other types of parameters, such as camera poses in a world coordinate system.

The auto-calibration system 108 can calibrate the sensors 104 to more accurately determine depths based on points and/or surfaces in the physical environment. The physical environment can be associated with one or more planes 110, such as a floor, walls, and/or a ceiling. The physical environment may also contain items 112, such as furniture or other objects. In some examples, the auto-calibration system 108 can calibrate the sensors 104 based on images showing planes 110 (or surfaces or intersections of planes and surfaces, such as corners) and/or items 112 in the physical environment. In some examples, a calibration chart 114 can be placed in the physical environment, for instance by mounting the calibration chart 114 on a wall. In these examples, the auto-calibration system 108 can calibrate the sensors 104 based on images showing the calibration chart 114, instead or in addition to the planes 110 and/or items 112.

To auto-calibrate the sensors 104, the auto-calibration system 108 can use one or more images or frames of the physical environment taken by the image components 106 or the other sensors 104 of the device 102 to determine a preliminary calibration accuracy of the sensors 104. For example, the images may be still images or frames captured from video that show one or more planes 110, one or more items 112, and/or the calibration chart 114. The auto-calibration system 108 can determine the preliminary calibration accuracy of the sensors 104 by determining an error distribution of estimated parameters associated with one or more sensors 104. As an example, the preliminary calibration accuracy can be an error distribution of depth values of a depth map determined based on depth information determined by the sensors 104 and/or corresponding points in the physical environment identified in images taken by image components 106 or other sensors 104 of the device. Such corresponding points may be points on the calibration chart 114, and/or arbitrary points on the planes 110 and/or the items 112 selected for use during the auto-calibration. In some examples, the error distribution can be a Gaussian distribution with a computed covariance. The error distribution can be computed analytically or be simulated via Monte-Carlo simulations or other types of numeric simulations.

If the preliminary calibration accuracy is at or above the threshold, the calibration of the sensor 104 or the image components 106 can be completed. In some examples, if the preliminary calibration accuracy is at or above the threshold, the auto-calibration system 108 can further process the images and/or other data on the device 102 to determine final calibration parameters. In other examples, if the preliminary calibration accuracy is at or above the threshold, the device 102 can transmit the images and/or other data to a server or other remote computing device via a communication interface 118, such as a Wi-Fi® data connection, cellular data connection, or other wired or wireless data connection (e.g., BlueTooth, Zigbee). In these examples, the server or other remote computing device can determine the final calibration parameters and transmit the final calibration parameters back to the device 102.

If a preliminary calibration accuracy of the sensors 104 or the image components 106 is below a threshold, the auto-calibration system 108 can provide feedback, via a user interface 120, indicating that a user 116 of the device 102 should use the device 102 to take additional images of the physical environment, for example, from different angles or viewpoints, or cause the device 102 automatically take such additional images of the physical environment. In some cases, the feedback may include user instructions, videos, or the like instructing the user 116 on how to capture the additional images. The auto-calibration system 108 can use the additional images of the physical environment, along with the previously captured images of the physical environment, to determine a new preliminary calibration accuracy. If the new preliminary calibration accuracy is at or above the threshold, the calibration of the sensors 104 or the image components 106 can be completed. If the new preliminary calibration accuracy is still below the threshold, the process can repeat until enough images are taken and a corresponding preliminary calibration accuracy meets or exceeds the threshold.

In some examples, the user interface 120 may include a screen or other display (such as a touch enabled display) that can present information to the user 116 indicating whether auto-calibration of the sensors 104 should be performed, a quality index indicating the state of the current device calibration, a state or progress of the auto-calibration, an indication of whether additional images should be taken for the auto-calibration, an indication that the auto-calibration has completed, and/or other information associated with the auto-calibration of the sensor. As an example, during the auto-calibration process, a user interface 120 of the device 102 can display a progress bar, a color indicator, a heatmap of preliminary determinations of depth quality information overlaid over a captured image, and/or other qualitative feedback associated with the auto-calibration process. As another example, the user interface may also, or alternately, display quantitative feedback associated with the auto-calibration process, such as preliminary depth accuracy determinations expressed in error percentages, millimeters, a relative quality index, or other units.

For instance, the user interface 120 may display a diagnosis mode of depth quality, and/or assist the user 116 during image capture for the auto-calibration process. For example, the user interface may ask the user 116 to capture images showing a surface the auto-calibration system 108 determines may be planar or substantially planar, such that the auto-calibration system 108 can determine a corresponding set of quality metrics. The quality metrics can include reconstructed depth coverage, residual error after inscribing a plane to 3D points, and/or other quality metrics.

As another example, the user interface 120 of the device 102 can provide feedback associated with images that may not be usable during the auto-calibration process, such as indications that certain images are too blurry, have insufficient lighting, do not capture enough of the calibration chart 114, were captured too far away from the calibration chart 114, were captured too close to the calibration chart 114, and/or other issues. The auto-calibration system 108 may, in some examples, automatically discard such images that may not be usable, and use the user interface 120 to request that the user 116 take additional or replacement images. The user interface may also indicate hints about how to fix issues with such unusable images when taking replacement images, or suggest angles or positions for subsequent images.

The calibration can be performed based on differently-oriented surfaces in the physical environment. The calibration can also simultaneously or iteratively optimize camera poses and/or calibration parameters to increase consistency of geometry in the physical environment captured from different images. Such consistency can be determined based on metrics such as point proximity, surface normal directions, and/or other metrics. The calibration can be performed by optimizing camera parameters and/or to calibrate a residual depth-error field, such as a 3D field of 3D point displacements in a camera frustum or a two-dimensional (2D) field of disparity corrections.

In some examples, the auto-calibration system 108 can request that the user 116 use the device 102 to take one or more images of the physical environment by image components 106 or the sensors 104 of the device 102. In some examples, the user 116 can mount the device 102 on a tripod or other stabilizer when such images are captured. In addition, the IMU 122 in device 102 may be used to determine whether the device was in motion at the moment of image capture. The device 102 can be moved to different positions during image capture, for instance by taking one or more images at a first position, taking one or more images at a second position, and so on. The auto-calibration system 108 may request that the user 116 take pairs of images at individual positions, such as a first image taken while an infrared projector is on and a second image taken while the infrared projector is off. Such paired images can be used to combine reprojection errors and geometrical inconsistency as a cost to be minimized during determination of an optimal set of calibration parameters. Minimization of a cost function is described in further detail below.

In some examples, the auto-calibration system 108 can calibrate camera or image component parameters of the device 102 and a relative position of the device 102 against image component or sensors of another related device. For instance, if the device 102 is an attachment or peripheral that can be connected to a smartphone, the auto-calibration system 108 can calibrate parameters for sensors 104 of the device 102 and a relative position of the sensors 104 of the device 102 against one or more cameras of the smartphone.

Overall, the auto-calibration system 108 can analyze frames captured from an arbitrary scene that contains planar surfaces, such as walls, a floor, a ceiling, tables, furniture, and books and shelves. The auto-calibration system 108 can use the planar surfaces to calculate surface normals and can use the surface normals to determine a quality of a current calibration. The quality of the current calibration can be determined by checking the parallelism of the surface normals. An angular spread, measured by the total spread and/or the variance of the surface normals, can be proportional to the quality of the current calibration. In some examples, the angular spread of the surface normals can also be used to update and improve the calibration.

In an additional example, the quality of the calibration can be determined by comparing the distribution of angular spreads of non-planar surfaces that were captured by the same sensor or device under better calibration conditions (e.g., at a previous date), or against that which were captured by other, better calibrated sensors or devices.

In some examples, machine learning techniques can be used to detect objects in the scene that may be expected to have parallel surface normals, such as walls, a floor, a ceiling, tables, furniture, and books and shelves. Detection of such objects may be used to determine when a calibration process should be performed that can automatically improve sensor calibration.

The auto-calibration system 108 can also have, in some examples, a thermal calibration mode that estimates how calibration parameters would change based on temperature changes. For example, the device 102 can have thermometers or other thermal sensors, such as infrared cameras, at one or more positions. In these examples, the device 102 may be configured to capture frames during calibration based on a determination that measurements from the thermal sensors are within a certain range, but skip frame capture if the thermal measurements are outside that range. If the thermal measurements are outside the range, a warning or other notification can be displayed to a user.

In some examples, the device 102 can be kept on a tripod or otherwise kept in a static position in front of the calibration chart 114. While in such a static position, the device 102 can capture temperature measurements and images, and compute a dependency of the camera parameters on the temperature and/or estimate a set of coefficients of a predefined dependency model. For example, the predefined dependency model can represent a dependency of one or more camera parameters on the temperature, and the coefficients of the predefined dependency model can be determined during a thermal calibration procedure. As another example, the predefined dependency model can represent a dependency of a final depth distortion on the temperature, and the coefficients of the predefined dependency model can be determined during a thermal calibration procedure. In these examples, measured temperatures associated with image components 106 and/or the sensors 104 during calibration can be saved, such that the auto-calibration system 108 can display a warning, via user interface, about potential quality degradation if the user 116 uses the device 102 when a temperature is outside a temperature range associated with the temperature determined during calibration. In addition, the warning about the potential quality degradation may include a calibration quality index, providing the user with a qualitative indication of the calibration degradation.

In the current example, the auto-calibration system 108 is shown as a component or system of the device 102. However, it should be understood that the auto-calibration system 108 may be implemented in software or as downloadable instructions or application that may be stored on a computer readable media of the device 102 and executed by one or more processors of the device 102. In some cases, the computer readable media may also store data, measurements, images, and the like generated by the sensors 104, the image components 106, the IMUs 122, and the like, such that the auto-calibration system 108 or application may access the data during calibration or other uses.

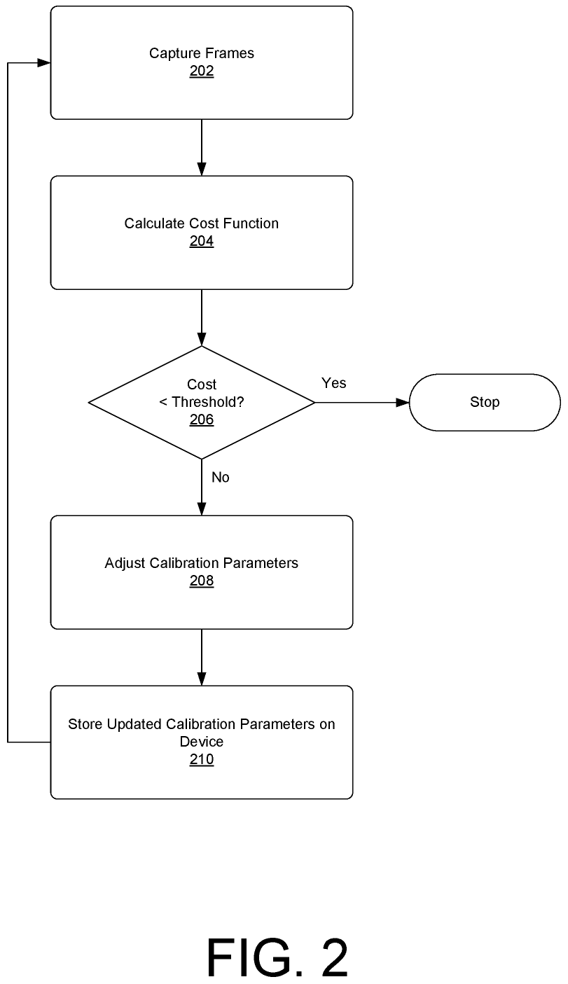

FIGS. 2-5 are flow diagrams illustrating example processes associated with the auto-calibration system of FIG. 1 according to some implementations. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 illustrates an example flow diagram showing a process 200 for auto-calibrating one or more sensors 104 of the device 102 according to some implementations. For example, as discussed above, over time error or drift may be introduced into one or more of the intrinsic parameters of the image components 106 or the sensors 104 of the device 102 and cause discrepancies when the device 102 is used to scan or capture image data of a 3D environment. In some cases, such as in 3D environmental modeling applications as well as in extended, mixed, or virtual reality systems the error or drift may be an issue.

At block 202, the device 102 can capture one or more frames. The frames can include frames of depth information captured by the sensors 104. The frames can also include still images, or frames extracted from captured video, captured by image components 106, infrared sensors, and/or other sensors 104 of the device 102.

At block 204, the frames captured at block 202 can be used to calculate a cost function. The cost function can be a derived from a comparison between the state of the captured frames against a predetermined expected state of those frames. Without loss of generality, the cost function can be defined as a quantity to be minimized or maximized. For example, if the cost function is a quantity to be minimized, the cost function can be an error function. As another example, if the cost function is a quantity to be maximized, the cost function can be a quality metric. Examples of calibration parameters include intrinsic and extrinsic parameters. Examples of intrinsic parameters include focal length of the image components 106, decentering of the optical elements that comprise the image components 106 with respect to the center of the sensors 104, distortion parameters that represent image distortion generated by image components 106 using, for example a polynomial fit of arbitrary order representing one or more of tangential distortion and/or radial distortion. In one example, 6^{th} order polynomials are used to represent radial distortion coefficients while a second order polynomial is used to represent tangential components. Another example of parameters commonly used to represent the distortion generated by image components include the fisheye distortion model, according to which a polynomial fit is used to represent the relationship between the angle of the image as a function of the field position (distance from the center).

Examples of extrinsic calibration parameters include the rotation and displacement parameters describing the changes in position and pose between two or more image components and sensors combinations. A cost function, for example, can be defined as the Euclidian distance from the points expected to be in a plane (for example, while imaging flat surfaces, such as a wall, floor or table) and the points in the depth map captured by the sensor, after applying the calibration parameters described above. When the aforementioned calibration parameters are exactly right, that Euclidian distance is minimized and tends towards zero, limited only by noise. On the other hand, when the calibration parameters deviate from optimum values, that Euclidian distance increases.

At block 206, the cost function calculated at block 204 can be compared to a corresponding threshold value. If the cost function is a quantity to be minimized, such that the cost function is an error function, and the cost function is below the threshold, the sensors 104 may be sufficiently calibrated and the auto-calibration process 200 can stop. However, if the cost function is at or above the threshold, the auto-calibration system 108 can adjust one or more calibration parameters at block 208 to incrementally reduce the cost function. The adjusted calibration parameters can be stored at block 210, and process 200 can repeat to capture more frames based on the adjusted calibration parameters and determine if the cost function has been reduced to below the threshold.

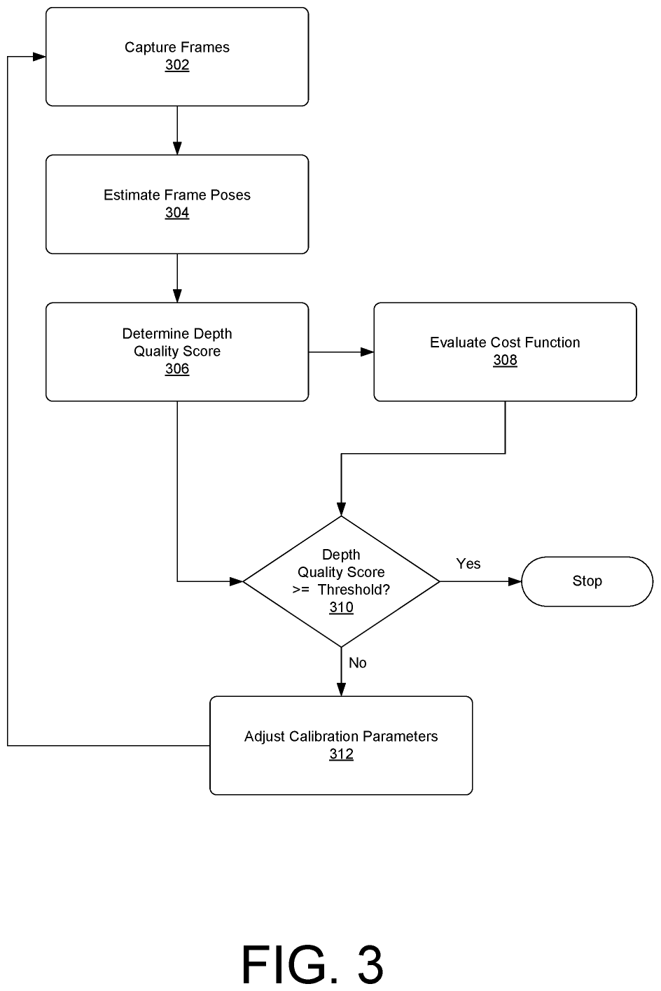

In some examples or situations, the cost function may be relatively small, for instance, if there is a relatively small number of measurements. Accordingly, in other examples or situations, the auto-calibration system 108 can calibrate the sensors 104 by using or optimizing a quality function instead of, or in addition to, the cost function, as discussed below with respect to FIG. 3.

FIG. 3 illustrates an example flow diagram showing a process 300 for auto-calibrating one or more sensors 104 or image components 106 of the device 102 according to some implementations. At block 302, the device 102 can capture one or more frames. The frames can include frames of depth information captured by the sensors 104. The frames can also include still images, or frames extracted from captured video, captured by the image components 106, infrared sensors, and/or the sensors 104 of the device 102.

At block 304, the auto-calibration system 108 can estimate poses or positions, in a world coordinate system, of the frames captured at block 302. In some examples, a frame position can be estimated using visual information, for instance by using descriptor (such as computer vision descriptors, SIFT, SURF, ORB, learned descriptors, SuperPoint, R2D2, LFNET, and the like) matches and a random sample consensus (RANSAC)-like procedure to detect inliers and optimizing a reprojection cost function, or by solving a perspective-n-point (PnP) problem associated with the calibration chart 114. As another example, a frame position can be estimated using depth information, for instance, by using Iterative Closest Point (ICP) point-to-plane procedures, matching 3D descriptors, and/other 3D data registration techniques. In still other examples, a frame position can be estimated using a combination of visual information and depth information.

At block 306, the auto-calibration system 108 can determine a depth quality score based on the frames captured at block 302 and the corresponding estimated frame positions determined at block 306. The depth quality score can be determined based on a quality function with one or more variables. The variables can include a projection error associated with known points on the calibration chart 114, reprojection errors of associated scene points observed in different images, a distance of a triangulated point and a known plane, a distance between triangulated points computed using different stereo pairs, a distance between a triangulated point computed for one stereo pair and a surface reconstructed for another stereo pair, an angle between surface normals reconstructed from different stereo pairs, a resulting depth covariance, resulting depth error distribution parameters, and/or other variables.

In some examples, in addition to determining the depth quality score at block 306, the auto-calibration system 108 can also evaluate a cost function at block 308. The cost function evaluated at block 306 can be similar to the cost function discussed above with respect to FIG. 2. For example, the auto-calibration system 108 can calculate a cost function, such as an error function or quality metric, based on the frames captured at block 302 and the corresponding estimated frame positions determined at block 306. In some examples, the cost function can be based on multiple weighted variables, or a non-linear function associated with such variables.

The variables can include a projection error associated with known points on the calibration chart 114, reprojection errors of associated scene points observed in different images, a distance of a triangulated point and a known plane, a distance between triangulated points computed using different stereo pairs, a distance between a triangulated point computed for one stereo pair and a surface reconstructed for another stereo pair, an angle between surface normal reconstructed from different stereo pairs, and/or other variables.

At block 310, the auto-calibration system 108 can determine whether the depth quality score determined at block 306 is equal to or above a corresponding threshold. If the depth quality score is at or above the threshold, the sensors 104 may be sufficiently calibrated and the auto-calibration process can stop. However, if the depth quality score determined at block 306 is below the threshold, the auto-calibration system 108 can adjust calibration parameters at block 310. In some examples, the calibration parameters can be adjusted at block 310 to minimize the cost function determined at block 308, as described above with respect to block 208 of FIG. 2. After adjusting the calibration parameters at block 310, the updated calibration parameters can be stored, and process 300 can repeat to capture more frames based on the adjusted calibration parameters and determine if the depth quality score has been increased to a value that is at or above the threshold.

The depth quality score estimation and/or cost function minimization performed during process 300, and/or other processes described herein, can be based on one or more techniques. For example, the depth quality score estimation and/or cost function minimization can be performed using a gradient descent method, a least-mean squares algorithm, a recursive least squares algorithm, Newton's method, a simplex algorithm, and/or other algorithms or methods.

In some examples, process 300 and/or other processes described herein can be performed for a single sensor. However, process 300 and/or other processes described herein can also be performed for multiple sensors 104 concurrently and/or at different times. For example, instances of process 300 can execute in series and/or in parallel to auto-calibrate multiple sensors 104.

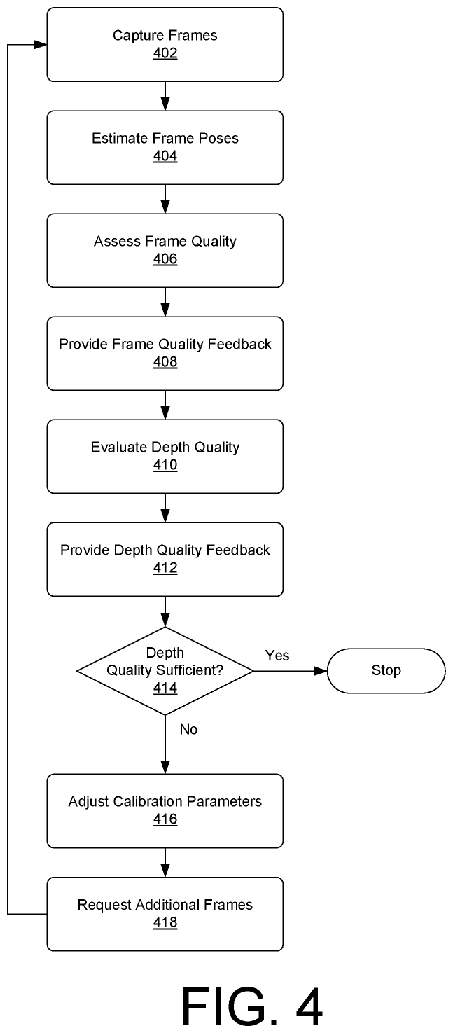

FIG. 4 illustrates an example flow diagram showing a process 400 for capturing frames and providing corresponding feedback during auto-calibration of one or more sensors 104 or image components 106 according to some implementations. For example, process 400 can be used to provide feedback to a user during execution of process 200 and/or process 300 described above.

At block 402, the device 102 can capture one or more frames. The frames can include frames of depth information captured by the sensors 104. The frames can also include still images, or frames extracted from captured video, captured by image components 106, infrared sensors, and/or the sensors 104 of the device 102.

At block 404, the auto-calibration system 108 can estimate poses or positions, in a world coordinate system, of the frames captured at block 402. The auto-calibration system 108 can estimate the poses or positions of the frames as described above with respect to block 304 of FIG. 3, for example, using visual information and/or depth information.

At block 406, the auto-calibration system 108 can assess quality levels of the frames captured at block 402. For example, the auto-calibration system 108 can determine one or more quality metrics associated with a particular frame, such as a blurriness metric, a distance to a previously captured scene, an angle at which the scene was captured, an exposure of the frame, a camera, sensor, or image component temperature, an estimated pose accuracy, a number of detected points on the calibration chart 114, coverage of scene features used for camera parameter optimization captured in the frame, and/or other metrics. In some cases, if a quality of a frame determined at block 406 is below a quality threshold level, the auto-calibration system 108 can discard that frame or avoid using the frame for sensor auto-calibration.

At block 408, the auto-calibration system 108 can provide frame quality feedback based on the quality levels of one or more frames determined at block 406. For example, if the quality level of a particular frame was too low to be used for sensor auto-calibration, the frame quality feedback can be a user notification presented via a user interface of the device that identifies a problem with the frame and/or suggestions on how to avoid that problem in the future. For instance, if a frame is rejected as being too blurry, a user notification may indicate that problem and suggest that the user 116 hold the device 102 more steady when capturing subsequent frames. In other examples in which a quality level of a frame is above a threshold level or is otherwise acceptable, the auto-calibration system 108 can provide frame quality feedback indicating that the frame is acceptable at block 408, or may skip block 408.

At block 410, the auto-calibration system 108 can evaluate depth quality levels of the frames captured at block 402. The depth quality level of a frame can be determined based on one or more variables, such as a projection error associated with known points on the calibration chart 114, reprojection errors of associated scene points observed in different images, a distance of a triangulated point and a known plane, a distance between triangulated points computed using different stereo pairs, a distance between a triangulated point computed for one stereo pair and a surface reconstructed for another stereo pair, an angle between surface normal reconstructed from different stereo pairs, a resulting depth covariance, resulting depth error distribution parameters, and/or other variables.

At block 412, the auto-calibration system 108 can provide depth quality feedback based on the depth quality levels of one or more frames determined at block 410. The depth quality feedback can be provided via a user interface of the device 102 as a status bar or other indictor that increases as a resulting depth metric becomes more accurate, as a root mean square error (RMSE) residual error in metrical units or other units, as color-coded map of a depth frame at a predefined distance, and/or as any other indication of the determined depth quality.

At block 414, the auto-calibration system 108 can determine whether the depth quality levels of one or more frames determined at block 410 are sufficient. For example, the auto-calibration system 108 can determine whether the depth quality levels meet or exceed one or more threshold values. If the depth quality levels are determined to be sufficient at block 410, process 400 may stop. In some examples, the auto-calibration system 108 can cause the device 102 to present a user notification indicating that the process 400 has stopped and/or that auto-calibration of the sensors 104 is complete.

However, if the depth quality levels determined at block 414 are insufficient, for instance, because the depth quality levels are below a threshold, the auto-calibration system 108 can adjust calibration parameters at block 416. In some examples, the calibration parameters can be adjusted at block 416 to minimize a cost function, as described above with respect to block 208 of FIG. 2 and block 312 of FIG. 3. After adjusting the calibration parameters at block 416, the updated calibration parameters can be stored. At block 418, the auto-calibration system 108 can also request that additional frames be captured. For example, the auto-calibration system 108 can cause the device 102 to present a user notification requesting that the user use the device 102 to capture additional frames. The user notification may indicate requested angles, frame positions, or other attributes that the user may use to capture additional frames. Process 400 can then repeat based on the additional frames, captured based on the adjusted calibration parameters, and determine if the depth quality levels have been increased to a sufficient level.

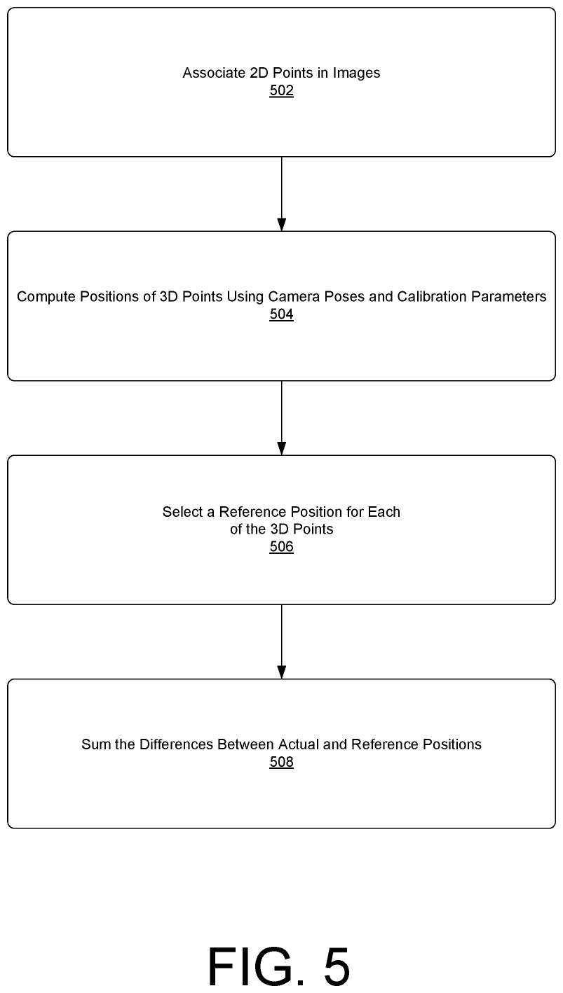

FIG. 5 illustrates an example flow diagram showing a process 500 for determining a geometry cost function according to some implementations. In some examples, process 500 can be performed by processors or other computing elements of a sensor, such as a camera or depth sensor. In other examples, process 500 can be performed by the auto-calibration system 108 or other elements of the device 102.

At block 502, 2D points in images can be associated. The 2D points can be associated based on template matching, descriptor matching, and/or other association techniques. A matching procedure performed at block 502 can result in an initial or preliminary guess about mutual frame positions, such as estimated frame poses or camera extrinsic parameters.

At block 504, 3D positions of the points can be computed based on associations of 2D points determined at block 502 and camera, sensor, or image component parameters, such as poses and calibration parameters. For example, the 3D positions of the points can be determined by minimizing a reprojection error, by converting disparity to depth for rectified images, by finding a middle of a common perpendicular of converging rays, by triangulation techniques, and/or by other techniques.

At block 506, a reference position for each of the 3D points determined at block 504 can be selected. A reference position can be a projection of a 3D point to a detected 3D plane and/or reference plane, a virtual 3D landmark, a closest 3D point triangulated from another stereo pair, or other position.

At block 508, the cost function can be determined based on the positions of the points determined at block 504 and the reference positions determined at block 506. For example, the cost function can be determined as a sum of squared differences between a 3D point and a corresponding reference position. As another example, the cost function can be determined as a sum of squared distances between a 3D point and a corresponding reference plane.

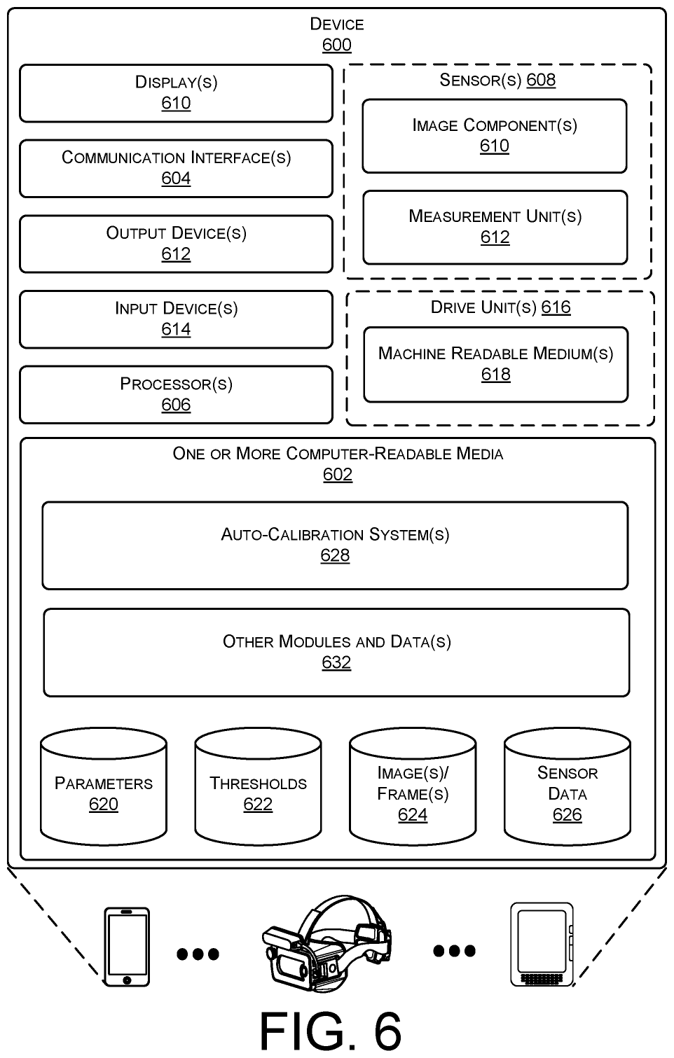

FIG. 6 shows an example system architecture 600 for the device 102 described herein. The device 102 can include sensors 608, including image components 610 (e.g., cameras), IMUs 612, and other types of sensors, as discussed above. The device 102 can also include one or more computer readable media 602. In various examples, the one or more computer readable media 602 can include system one or more computer readable media, which may be volatile (such as RAM), non-volatile (such as ROM, flash memory, etc.) or some combination of the two. The one or more computer readable media 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the device 102. Any such non-transitory computer-readable media may be part of the device 102.

The one or more computer readable media 602 can store computer-executable instructions and other data associated with the auto-calibration system 628 discussed above. The one or more computer readable media 602 can also store other modules 604. The other modules 604 can be utilized by the device 102 to perform or enable performing any action taken by the device 102. For example, the other modules ta 604 can include a platform, operating system, and/or applications. The computer readable media 602 may also store data utilized by the platform, operating system, and/or applications, such as parameters 620, thresholds 622, images or frames 622 (e.g., image data) and/or sensor data 626. In some cases, the parameters 620 may be calibration parameters for use in calibrating the sensors 608 including the image components 610 and/or the measurement units 612. As some illustrative examples, the calibration parameters 620 include the rotation and displacement parameters describing the changes in position and pose between two or more image components and sensors combinations. A cost function, for example, can be defined as the Euclidian distance from the points expected to be in a plane (for example, while imaging flat surfaces, such as a wall, floor or table) and the points in the depth map captured by the sensor, after applying the calibration parameters described above. When the aforementioned calibration parameters are exactly right, that Euclidian distance is minimized and tends towards zero, limited only by noise. On the other hand, when the calibration parameters deviate from optimum values, that Euclidian distance increases.

The device 102 can also have processor(s) 606, communication interfaces 604, displays 610, output devices 612, input devices 614, and/or a drive unit 616 including a machine readable medium 618. In various examples, the processor(s) 606 can be a central processing unit (CPU), a graphics processing unit (GPU), both a CPU and a GPU, or any other type of processing unit. Each of the one or more processor(s) 606 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 606 may also be responsible for executing computer applications stored in the one or more computer readable media 602, which can be associated with types of volatile (RAM) and/or nonvolatile (ROM) memory.

The communication interfaces 604 can include transceivers, modems, network interfaces, antennas, wireless communication interfaces, and/or other components that can transmit and/or receive data over networks or other data connections.

The display 610 can be a liquid crystal display or any other type of display commonly used in computing devices The output devices 612 can include any sort of output devices known in the art, such as a display 610, speakers, a vibrating mechanism, and/or a tactile feedback mechanism. Output devices 612 can also include ports for one or more peripheral devices, such as headphones, peripheral speakers, and/or a peripheral display. The input devices 614 can include any sort of input devices. For example, input devices 614 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism. In some examples, the input devices 614 can include one or more of the sensors 608. In some examples, the display 610, input devices 614 and the output devices 612 may be combined in a touch-sensitive display or screen.

The machine readable medium 618 can store one or more sets of instructions, such as software or firmware, that embodies any one or more of the methodologies or functions described herein. The instructions can also reside, completely or at least partially, within the one or more computer readable media 602, processor(s) 606, and/or communication interface(s) 604 during execution thereof by the device 102. The one or more computer readable media 602 and the processor(s) 606 also can constitute machine readable media 618.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A system comprising:
a user interface to present instruction to a user;
an image component for capturing one or more frames of a physical environment surrounding the system;
one or more processors;
one or more non-transitory computer readable media storing one or more calibration parameters and instructions executable by the one or more processors, wherein the instructions, when executed, cause the system to perform operations comprising:
determining a cost based at least in part on a cost function, one or more calibration parameters, and the one or more frames;
responsive to determining that the cost is greater than or equal to a threshold, determining an adjustment to at least one calibration parameter associated with the image component; and
applying the adjustment to the calibration parameters.

2. The system of claim 1, further comprising:
an inertial measurement unit (IMU) to generate IMU data associated with the system; and
wherein determining the cost is based at least in part on the IMU data.

3. The system of claim 1, wherein the operations further comprise:
estimating a pose associated with individual ones of the one or more frames;
determining a depth quality score associated with the individual ones of the one or more frames; and
wherein the cost is based at least in part on the depth quality score.

4. The system of claim 3, wherein the operations further comprise:
estimating a pose associated with individual ones of the one or more frames;
determining a depth quality score associated with the individual ones of the one or more frames; and
wherein determining the adjustment to the at least one parameter associated with the image component is responsive to the depth quality score being greater than or equal to a depth quality threshold.

5. The system of claim 1, further comprising:
a user interface to present instruction to a user; and
wherein:
the operations further comprise:
determining a depth quality score associated with a first frame of the one or more frames; and
responsive to determining the depth quality score is less than or equal to a depth quality threshold, presenting instruction to cause a user to capture
an additional frame; and
determining the cost is based at least in part the additional frame.

6. The system of claim 5, wherein the instruction include at least a target for the additional frame.

7. The system of claim 1, wherein a first frame of the one or more frames includes data representative of at least one of the following:
a surface;
a comer;
a calibration chart; or
an item.

8. The system of claim 1, wherein the operations further comprise:
receiving additional frames from the image component;
determining a second cost based at least in part on the cost function and the additional frames;
responsive to determining that the second cost is greater than or equal to the threshold, determining a second adjustment to at least one parameter associated with the image component;
applying the second adjustment to the calibration parameters.

9. One or more non-transitory computer-readable media storing instructions that, when executed, cause one or more processors to perform operations comprising:
receiving a frame from an image component;
determining a cost associated with the image component based at least in part on the frame;
responsive to determining that the cost is greater than or equal to a threshold, determining an adjustment to at least one parameter associated with the image component;
applying the adjustment to the least one parameter to generate at least one adjusted parameter.

10. The one or more non-transitory computer-readable media of claim 9, wherein determining the cost is based at least in part on IMU data associated with the image component.

11. The one or more non-transitory computer-readable media of claim 9, wherein applying the adjustment to the least one parameter further comprises storing the at least one adjusted parameter in a location accessible to the image component.

12. The one or more non-transitory computer-readable media of claim 9, wherein the operations further comprise:
estimating a pose associated with the frame;
determining a depth quality score associated with the frame based at least in part on the pose; and
wherein the cost is based at least in part on the depth quality score.

13. The one or more non-transitory computer-readable media of claim 9, wherein the operations further comprise:
estimating a pose associated with the frame;
determining a depth quality score associated with the frame; and
wherein determining the adjustment to the at least one parameter associated with the image component is responsive to the depth quality score being greater than or equal to a depth quality threshold.

14. The one or more non-transitory computer-readable media of claim 9, wherein the operations further comprise:
determining a depth quality score associated with the frame; and
responsive to determining the depth quality score is less than or equal to a depth quality threshold, presenting instruction on a display to cause a user to capture an additional frame; and
determining the cost is based at least in part the additional frame.

15. The one or more non-transitory computer-readable media of claim 9, wherein determining the cost is based at least in part on the at least one parameter.

16. A method comprising:
receiving a frame from an image component, the frame including data representative of a target;
determining a cost associated with the image component based at least in part on the data representative of a target;
responsive to determining that the cost is greater than or equal to a threshold, determining an adjustment to a parameter associated with the image component;
applying the adjustment to the parameter.

17. The method of claim 16, wherein determining the cost is based at least in part on IMU data associated with the image component.

18. The method of claim 16, wherein the operations further comprise:
estimating a pose associated with the frame;
determining a depth quality score associated with the frame based at least in part on the pose; and
wherein determining the adjustment to the parameter is responsive to the depth quality score being greater than or equal to a depth quality threshold and the cost is based at least in part on the depth quality score.

19. The method of claim 16, wherein the operations further comprise:
determining a depth quality score associated with the frame; and
responsive to determining the depth quality score is less than or equal to a depth quality threshold, presenting instruction on a display to cause a user to capture an additional frame; and
determining the cost is based at least in part the additional frame.

20. The method of claim 16, wherein the operations further comprise:
estimating a pose associated with the frame;
determining a depth quality score associated with the frame based at least in part on the pose; and
presenting the depth quality score on a display.
